(19) United States
(12) Patent Application Publication
(10) Pub. No.: US 2020/0353932 A1
(43) Pub. Date: Nov. 12, 2020

(54) TRAFFIC LIGHT DETECTION METHOD AND APPARATUS, INTELLIGENT DRIVING METHOD AND APPARATUS, VEHICLE, AND ELECTRONIC DEVICE

(71) Applicant: BEIJING SENSETIME TECHNOLOGY DEVELOPMENT CO., LTD., BEIJING (CN)

(72) Inventors: HEZHANG WANG, BEIJING (CN); YUCHEN MA, BEIJING (CN); TIANXIAO HU, BEIJING (CN); XINGYU ZENG, BEIJING (CN); JUNJIE YAN, BEIJING (CN)

(21) Appl. No.: 16/944,234

(22) Filed: Jul. 31, 2020

Related U.S. Application Data
(63) Continuation of application No. PCT/CN2019/089062, filed on May 29, 2019.

(30) Foreign Application Priority Data
Jun. 29, 2018 (CN) 201810697683.9

(51) Int. Cl. B60W 30/18; G06N 3/04; G06K 9/00; G05D 1/02

(52) U.S. Cl. CPC B60W 30/18159; G06N 3/04; B60W 2552/53; G05D 1/0221; B60W 30/18154; G06K 9/00825

(57) ABSTRACT

Embodiments of the present disclosure disclose a traffic light detection method and apparatus, an intelligent driving method and apparatus, a vehicle, and an electronic device. The traffic light detection method includes: obtaining a video stream including a traffic light; determining a candidate region of the traffic light in at least one frame of image of the video stream; and determining at least two attributes of the traffic light in the image based on the candidate region.

### CROSS REFERENCE TO RELATED APPLICATIONS

The present application is a continuation application of International Application No. PCT/CN2019/089062, filed on May 29, 2019, which claims priority to and benefits of claims priority to Chinese Patent Application No. CN201810697683.9, filed with the Chinese Intellectual Property Office on Jun. 29, 2018 and entitled “TRAFFIC LIGHT DETECTION METHOD AND APPARATUS, INTELLIGENT DRIVING METHOD AND APPARATUS, VEHICLE, AND ELECTRONIC DEVICE”, all of which are incorporated herein by reference in their entirety.

### TECHNICAL FIELD

The present disclosure relates to computer vision technologies, and in particular, to a traffic light detection method and apparatus, intelligent driving method and apparatus, a vehicle, and an electronic device.

### BACKGROUND

Traffic light detection and its state determination are important problems in the field of intelligent driving. Traffic lights are important traffic signals and play an irreplaceable role in modern traffic systems. The traffic light detection and its state determination can indicate stopping or advancing of a vehicle in automatic driving so as to ensure safe driving of the vehicle.

### SUMMARY

Embodiments of the present disclosure provide traffic light detection and intelligent driving technology.

A traffic light detection method is provided according to one aspect of the embodiments of the present disclosure, and a detection network includes: a Region-based Fully Convolutional Network (R-FCN) and a multi-task identification network, including:

obtaining a video stream including a traffic light;

determining candidate regions of the traffic light in at least one frame of image of the video stream; and

determining at least two attributes of the traffic light in the image based on the candidate regions.

An intelligent driving method provided according to another aspect of the embodiments of the present disclosure includes:

obtaining a video stream including a traffic light based on an image acquisition apparatus provided on a vehicle;

determining candidate regions of the traffic light in at least one frame of image of the video stream;

determining at least two attributes of the traffic light in the image based on the candidate regions;

determining a state of the traffic light based on the at least two attributes of the traffic light in the image; and

performing intelligent control on the vehicle according to the state of the traffic light.

A traffic light detection apparatus provided according to still another aspect of the embodiments of the present disclosure includes:

a video stream obtaining unit, configured to obtain a video stream including a traffic light;

a region determination unit, configured to determine candidate regions of the traffic light in at least one frame of image of the video stream; and

an attribute identification unit, configured to determine at least two attributes of the traffic light in the image based on the candidate regions.

An intelligent driving apparatus provided according to yet another aspect of the embodiments of the present disclosure includes:

a video stream obtaining unit, configured to obtain a video stream including a traffic light based on an image acquisition apparatus provided on a vehicle;

a region determination unit, configured to determine candidate regions of the traffic light in at least one frame of image of the video stream;

an attribute identification unit, configured to determine at least two attributes of the traffic light in the image based on the candidate regions;

a state determination unit, configured to determine a state of the traffic light based on the at least two attributes of the traffic light in the image; and

an intelligent control unit, configured to perform intelligent control on the vehicle according to the state of the traffic light.

A vehicle provided according to yet another aspect of the embodiments of the present disclosure includes the traffic light detection apparatus according to any one of the foregoing embodiments or the intelligent driving apparatus according to any one of the foregoing embodiments.

An electronic device provided according to yet another aspect of the embodiments of the present disclosure includes a processor, where the processor includes the traffic light detection apparatus according to any one of the foregoing embodiments or the intelligent driving apparatus according to any one of the foregoing embodiments.

An electronic device provided according to another aspect of the embodiments of the present disclosure includes: a memory, configured to store executable instructions;

and a processor, configured to communicate with the memory to execute the executable instructions so as to complete operations of the traffic light detection method according to any one of the foregoing embodiments or operations of the intelligent driving method according to any one of the foregoing embodiments.

A computer readable storage medium provided according to still another aspect of the embodiments of the present disclosure is configured to store computer readable instructions, where when the instructions are executed, operations of the traffic light detection method according to any one of the foregoing embodiments or operations of the intelligent driving method according to any one of the foregoing embodiments are executed.

A computer program product provided according to another aspect of the embodiments of the present disclosure includes a computer readable code, where when the computer readable code runs in a device, a processor in the device executes instructions for implementing the traffic light detection method according to any one of the foregoing embodiments or the intelligent driving method according to any one of the foregoing embodiments.

Based on the traffic light detection and intelligent driving method and apparatus, the vehicle, and the electronic device provided according to the embodiments of the present disclosure, a video stream including a traffic light is obtained; candidate regions of the traffic light in at least one frame of image of the video stream are determined; and at least two attributes of the traffic light in the image are determined based on the candidate regions. By obtaining the at least two attributes of the traffic light, identification of multiple information of the traffic light is realized, thereby reducing the identification time and improving the identification accuracy of the traffic light.

The following further describes in detail the technical solutions of the present disclosure with reference to the accompanying drawings and embodiments.

### BRIEF DESCRIPTION OF THE DRAWINGS

The accompanying drawings constituting a part of the specification describe the embodiments of the present disclosure and are intended to explain the principles of the present disclosure together with the descriptions.

According to the following detailed description, the present disclosure can be understood more clearly with reference to the accompanying drawings.

FIG. 1 is a schematic flowchart of a traffic light detection method provided according to the present disclosure.

FIG. 2 is a schematic structural diagram of a traffic light detection apparatus provided according to the present disclosure.

FIG. 3 is a schematic flowchart of an intelligent driving method provided according to the present disclosure.

FIG. 4 is a schematic structural diagram of an intelligent driving apparatus provided according to the present disclosure.

FIG. 5 is a schematic structural diagram of an electronic device, which may be a terminal device or a server, suitable for implementing the embodiments of the present disclosure.

### DETAILED DESCRIPTION OF THE EMBODIMENTS

Various exemplary embodiments of the present disclosure are now described in detail with reference to the accompanying drawings. It should be noted that, unless otherwise stated specifically, relative arrangement of the components and steps, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to a computer system/server, which may operate with numerous other general-purpose or special-purpose computing system environments or configurations. Examples of well-known computing systems, environments, and/or configurations suitable for use together with the computer system/server include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems, and the like.

The computer system/server may be described in the general context of computer system executable instructions (for example, program modules) executed by the computer system. Generally, the program modules may include routines, programs, target programs, components, logics, data structures, and the like for performing specific tasks or implementing specific abstract data types. The computer system/server may be practiced in the distributed cloud computing environments in which tasks are performed by remote processing devices that are linked through a communications network. In the distributed computing environments, the program modules may be located in local or remote computing system storage media including storage devices.

FIG. 1 is a schematic flowchart of a traffic light detection method provided according to the present disclosure. The method may be performed by any electronic device, such as a terminal device, a server, a mobile device, and a vehicle-mounted device. As shown in FIG. 1, the method in the embodiments includes the following steps.

At step 110, a video stream including a traffic light is obtained.

Optionally, identification of a traffic light is generally performed based on a vehicle-mounted video recorded in the traveling process of a vehicle. The vehicle-mounted video is parsed to obtain a video stream including at least one frame of image. For example, a video of a forward or surrounding environment of the vehicle can be photographed through a camera apparatus mounted on the vehicle, and if a traffic light exists in the forward or surrounding environment of the vehicle, the traffic light may be photographed by the camera apparatus, and the photographed video stream is a video stream including the traffic light. For the image in the video stream, each frame of image includes the traffic light, or at least one frame of image includes the traffic light.

In one optional example, step 110 may be performed by a processor by invoking a corresponding instruction stored in a memory, or may be performed by a video stream obtaining module 21 run by the processor.

At step 120, candidate regions of the traffic light in at least one frame of image of the video stream are determined.

Optionally, candidate regions are determined from an image of the video stream including the traffic light, and the candidate regions refer to regions which may include the traffic light in the image.

Detection of the region of the traffic light may be performed based on a neural network or other types of detection models.

In one or more optional embodiments, candidate regions of the traffic light in at least one frame of image of the video stream are determined by using the R-FCN. The signal image is detected through the R-FCN, and candidate regions which may include the traffic light are obtained. The R-FCN can be regarded as an improved version of a Faster Region with CNN (Faster RCNN), and the detection speed thereof is faster than the Faster RCNN.

In one optional example, step 120 may be performed by a processor by invoking a corresponding instruction stored in a memory, and may also be performed by a region determination unit 22 run by the processor.

At step 130, at least two attributes of the traffic light in the image are determined based on the candidate regions.

The attributes of the traffic light are used for describing the traffic light, and may be defined according to actual needs, for example, being capable of including a position region attribute for describing an absolute position or relative position of the traffic light, an attribute for describing colors (such as red, green, and yellow) of the traffic light, an attribute for describing shapes (such as circle, linear arrow, and fold line arrow) of the traffic light, and other attributes for describing other aspects of the traffic light.

Optionally, the at least two attributes of the traffic light include any two or more of: a position region, colors, and a shape.

Optionally, the colors of the traffic light include red, yellow and green, and the shape thereof includes an arrow shape, a circle or other shapes. For the traffic lights in different shapes, if only the position of the traffic light is recognized, the signal cannot be identified accurately. Therefore, the embodiments are based on identification of at least two of the position region, the colors, and the shape, for example, when the position region and the color of the traffic light are determined, the position of the current traffic light in the image (corresponding to which direction of the vehicle) may be determined, a display state (red, green, or yellow correspond to different states respectively) of the traffic light may be determined through the color, and auxiliary driving or automatic driving may be realized by identifying different states of the traffic light; when the position region and the shape of the traffic light are determined, the position of the current traffic light in the image (corresponding to which direction of the vehicle) may be determined, and the display state (for example, arrows towards different directions represent human body graphs in different states or different shapes represent different states) of the traffic light may be determined through the shape; when the color and the shape of the traffic light are determined, the state of the current traffic light may be determined based on a combination of the color and the shape (for example, the green arrow pointing to the left represents a left turn, and the red arrow pointing to the front represents passing forbidden ahead); and when the position region, the color, and the shape of the traffic light are determined, on the basis that the position of the traffic light in the image is obtained, the state of the current traffic light may be determined based on the combination of the color and the shape. According to the embodiments, by combining two or more of the three attributes, the attribute characteristics of the traffic light may be highlighted, thereby facilitating improving the processing effects such as detection and identification.

In one optional example, step 130 may be performed by a processor by invoking a corresponding instruction stored in a memory, or may be performed by an attribute identification unit 23 run by the processor.

Based on the traffic light detection method provided according to the embodiments of the present disclosure, a video stream including a traffic light is obtained; candidate regions of the traffic light in at least one frame of image of the video stream are determined; and at least two attributes of the traffic light in the image are determined based on the candidate regions. By obtaining the at least two attributes of the traffic light, identification of multiple information of the traffic light is realized, thereby reducing the identification time and improving the identification accuracy of the traffic light.

Determination of the at least two attributes of the traffic light may be performed based on a neural network or other types of identification models. In one or more optional embodiments, the operation 130 may include:

determining, by using a multi-task identification network, at least two attributes of the traffic light in the image based on the candidate regions.

In the embodiments, at least two attributes of the traffic light are identified through a network, and compared with the condition that at least two attributes are identified based on at least two networks respectively, the size of the network is reduced, and the attribute identification efficiency of the traffic light is improved.

Candidate regions which may include the traffic light are identified through the multi-task identification network. The identification process may include feature extraction and attribute identification. In order to achieve the functions of the two parts, the multi-task identification network may include a feature extraction branch, and at least two task branches which are respectively connected to the feature extraction branch, different task branches being used for determining different kinds of attributes of the traffic light.

Each attribute identification task needs to perform feature extraction on the candidate regions. In the embodiments, the feature extraction branch is respectively connected to at least two task branches, so that feature extraction operations of the at least two task branches are combined in the same feature extraction branch, and feature extraction is not required to be performed respectively on the at least two task branches, thereby reducing the structure of the multi-task identification network and accelerating the speed of attribute identification.

Optionally, the process of obtaining the at least two attributes may include:

performing feature extraction on the candidate regions based on the feature extraction branch to obtain candidate features; and

processing the candidate features respectively based on the at least two task branches to obtain at least two attributes of the traffic light in the image.

Optionally, the feature extraction branch may include at least one layer of convolution layer, and the candidate regions are used as input images. Feature extraction is performed on the candidate regions through the feature extraction branch to obtain candidate features (feature maps or feature vectors) of the candidate regions. Based on the candidate features, the position and color of the traffic light or the position and shape of the traffic light or the color and shape of the traffic light may be obtained through the at least two task branches. In one embodiment with a good effect, the color, the position, and the shape of the traffic light are simultaneously obtained through the multi-task branch. When the position of the traffic light is checked, the state of the current traffic light is identified through the color of the traffic light, so that a good application may be obtained in the field of automatic driving, and the identification accuracy of the traffic light may be improved by identifying the shape of the traffic light.

Optionally, the at least two task branches include, but are not limited to, a detection branch, an identification branch, and a classification branch.

The processing the candidate features respectively based on the at least two task branches to obtain at least two attributes of the traffic light in the image includes:

performing position detection on the candidate features through the detection branch to determine the position region of the traffic light;

performing color classification on the candidate features through the classification branch to determine a color of the position region at which the traffic light is located, and to determine a color of the traffic light; and

performing shape identification on the candidate features through the identification branch to determine a shape of the position region at which the traffic light is located, and to determine the shape of the traffic light.

In the embodiments, any two or three attributes of the position region, the color, and the shape of the traffic light may be identified through different branches, so that the time for multi-task identification is saved, the size of the detection network is reduced, and the multi-task identification network is faster in training and application processes. Moreover, if the position region of the traffic light is obtained first, the color and shape of the traffic light may be obtained faster. Because the traffic light generally only has three colors (red, green, and yellow), the identification of the color may be implemented using the trained classification branch (other network layers other than the convolution layer in a common multi-task identification network may be employed).

It is very difficult to detect the traffic light and determine its state in real scenes. First, the color determination of the traffic light is very difficult due to interference of environmental factors such as illumination and weather. Moreover, there are similar interference in complex real scenes, such as vehicle lights and street lights, which influences the detection of the traffic light. According to the embodiments of the present disclosure, more than two of the position region, the color, and the shape of the traffic light are detected at the same time, thereby improving the detection accuracy while saving the detection time.

In one or more optional embodiments, before step 120, the method may further include:

performing key point identification on the at least one frame of image in the video stream to determine a key point of the traffic light in the image;

tracking the key point of the traffic light in the video stream to obtain a tracking result; and

adjusting the position region of the traffic light based on the tracking result.

There may be little difference between consecutive frames of the video stream. If the position identification of the traffic light is performed only based on the candidate regions of the traffic light in at least one frame of image, the position regions in the consecutive frames may be identified to be the same position regions, and therefore the identified position regions are not accurate. In the embodiments, by performing key point identification on the image, the position region of the traffic light in the image is determined based on the key point, and the position of the traffic light obtained by the multi-task identification network is adjusted based on the position region of the key point, thereby improving the accuracy of position region identification.

Key point identification and/or tracking may be realized based on any one of the technologies that can achieve key point identification and/or tracking in the prior art. Optionally, the key point of the traffic light in the video stream may be tracked based on a static key point tracking technology, so as to obtain a region where the key point of the traffic light may be located in the video stream.

The position region of the traffic light is obtained through the detection branch. Missing detection of certain frames may be easily caused by little difference between consecutive images and selection of a threshold, and therefore, the detection effect of the detection network on a vehicle-mounted video is improved based on the static key point tracking technology.

The feature points of the image may be simply understood as relatively prominent points in the image, such as corner points and bright spots in a dark region. First, Oriented FAST and Rotated BRIEF (ORB) feature points in the video image are identified: the definition of the ORB feature points is based on an image gray value around the feature points; during detection, pixel values around candidate feature points are considered, and if enough pixel points exist in the field around the candidate points and a difference between the gray values of the pixel points and the candidate feature points reaches a predetermined value, the candidate points are considered as key feature points. The embodiments relate to identification of the key point of the traffic light. Therefore, the key point is the key point of the traffic light. Static tracking of the traffic light in the video stream may be realized by means of the key point of the traffic light. Since the traffic light occupies more than one pixel point in the image, that is, the key point of the traffic light obtained in the embodiments includes at least one pixel point, and it can be understood that the key point of the traffic light corresponds to one position region.

Optionally, the tracking the key point of the traffic light in the video stream includes:

being based on a distance between the key points of the traffic light in two consecutive frames of images; and

tracking the key point of the traffic light in the video stream based on the distance between the key points of the traffic light.

In the embodiments, the two consecutive frames may be two acquisition frames with consecutive time sequences in the video stream, or two detection frames with consecutive time sequences in the video stream (because frame-by-frame detection or sampling detection may be performed in the video stream, the meaning of the detection frame and the acquisition frame is not completely the same); the key points of the traffic light of a plurality of consecutive two frames of images in the video stream are correlated, so that the key point of the traffic light may be tracked in the video stream, and the position region of at least one frame of image in the video stream may be adjusted based on the tracking result. Optionally, the key point of the traffic light in the video stream may be tracked based on Hamming distance, Euclidean distance, Joint Bayesian distance, or cosine distance between the key points of the traffic light. The embodiments do not limit what distance between the key points of the traffic light is based.

The Hamming distance is used in data transmission error control coding. The Hamming distance is a concept that represents the number of different bits corresponding to two (identical length) words. Exclusive-OR operation is performed on two character strings, and the number of the results as 1 is counted, and thus the number is the Hamming distance. The Hamming distance between two images is the number of different data bits between the two images. On the basis of the Hamming distance between the key points of at least one traffic light in the two frame of signal images, the moving distance of the traffic light between the two signal images may be seen, that is, the key point of the traffic light may be tracked.

Optionally, the tracking the key point of the traffic light in the video stream based on the distance between the key points of the traffic light includes:

determining the position region of the key point of a same traffic light in the two consecutive frames of images based on the distance between the key points of the traffic light;

and

tracking the key point of the traffic light in the video stream according to the position region of the key point of the same traffic light in the two consecutive frames of images.

Traffic lights usually do not appear individually, and the traffic lights cannot be represented by one key point in the image, and therefore, the image includes the key point of at least one traffic light. Moreover, different traffic lights (for example, a forward traffic light and a left turn traffic light may be simultaneously displayed in the same image) need to be tracked respectively. In the embodiments, by tracking the key point of the same traffic light in the consecutive frames, the problem of disordered tracking of different traffic lights is solved.

Optionally, the position region of the key point of the same traffic light in the two consecutive frames of images may be determined based on a lower value (e.g., a minimum value) of the Hamming distance between the key points of at least one traffic light.

For example, a feature point (the key point of the traffic light) with a lower Hamming distance of an image coordinate system in the front frame and the rear frame may be matched through a brute force algorithm, that is, on the basis of the key points of each pair of traffic light, the Hamming distance of the feature points thereof is calculated, and on the basis of the key point of the traffic light having a lower value (e.g., a minimum value) of the Hamming distance, matching of the ORB feature points in the front frame and the rear frame is realized, and static feature point tracking is realized. Furthermore, because the image coordinate system of the key point of the traffic light is located in the candidate regions of the traffic light, it is determined that the key point of the traffic light is a static key point in traffic light detection. The brute force algorithm is a common mode matching algorithm. The brute force algorithm is to match the first character of a target string S with the first character of a pattern string T, and if equal, continue to compare the second character of S and the second character of T; and if not, compare the second character of S and the first character of T, and sequentially compare them until a final matching result is obtained. The brute force algorithm is a kind of brute force algorithm.

In one or more optional embodiments, the adjusting the position region of the traffic light based on the tracking result includes:

comparing whether the position region in the tracking result overlaps the position region of the traffic light to obtain a comparison result; and

adjusting the position region of the traffic light based on the comparison result.

The position region of the traffic light is adjusted based on the tracking result, so that the position region of the traffic light is more stable, and is more suitable for being applied to video scenes.

In the embodiments, the position region corresponding to the key point of the traffic light in at least one frame of image in the video stream may be determined based on the tracking result, and when the ratio of the overlapping part between the position region in the tracking result and the position region of the traffic light in the position region of the traffic light exceeds a set ratio, it can be determined that the position region in the tracking result overlaps the position region of the traffic light, and otherwise, the position region in the tracking result does not overlap the position region of the traffic light.

Optionally, the adjusting the position region of the traffic light based on the comparison result includes:

The position region of the traffic light is replaced with the position region corresponding to the key point of the traffic light in response to the position region corresponding to the key point of the traffic light not overlapping the position region of the traffic light.

The comparison result of whether the position region corresponding to the key point of the traffic light overlaps the position region of the traffic light in the traffic light image is obtained. The following three situations may be included.

If the position region corresponding to the key point of the traffic light matches (overlap) the position region of the traffic light, that is, the position region of the key point of the traffic light matched in the front frame and the rear frame is the same as the position region of the detected traffic light, no correction is required; if the position region of the key point of the traffic light approximately matches the position region of the detected traffic light, according to offset of the position region of the key point of the traffic light in the front frame and the rear frame, on the premise that the width and height of the position of the detected traffic light are kept unchanged, the position region of a current frame detection box is calculated according to movement of the position region of the key point of the traffic light. If the position region of the traffic light is not detected in the current frame, and the position region of the traffic light is detected in the last frame, it can be determined that the position region of the traffic light of the current frame does not exceed the range of a camera according to the key point of the traffic light; if the range is not exceeded, the position region of the traffic light of the current frame is determined based on the calculation result of the key point of the traffic light, so as to reduce missing detection.

In one or more optional embodiments, before the operation 120, the method may further include:

training the R-FCN based on an acquired training image set, the training image set including a plurality of training images with annotation attributes; and

adjusting parameters in the R-FCN and in the multi-task identification network based on the training image set.

In a real scene, the yellow light in the traffic lights is only a transition state between the red light and the green light, and therefore, the duration is shorter than that of the red light and the green light. In the prior art, the detection frame based on the R-FCN only inputs a limited image at a time, and the number of yellow lights in the image is less than that of the red light and the green light, and therefore, the detection network cannot be effectively trained, and the sensitivity of the model to the yellow light cannot be improved. Therefore, in the present disclosure, the position, the color, and/or the shape of the traffic light may be identified simultaneously by training the R-FCN and the multi-task identification network.

In order to improve the sensitivity of the detection network to the yellow light, optionally, before the adjusting parameters in the R-FCN and in the multi-task identification network based on the training image set, the method may further include:

obtaining, based on the training image set, a new training image set with a color proportion of the traffic light conforming to a predetermined proportion; and

training a classification network based on the new training image set, the classification network being configured to classify training images based on the color of the traffic light.

Optionally, the classification network is obtained by the detection network in the prior art by removing a candidate Region Proposal Network (RPN) and a proposal layer. Optionally, the classification network may correspondingly include a feature extraction branch and a classification branch in the multi-task identification network. The classification network is trained based on the new training image set with a predetermined proportion alone, so that the classification accuracy of the classification network on colors of the traffic lights may be improved.

The training image set of a training network is obtained by means of collection, and the acquired training image set is used for training the R-FCN. The number of red lights, green lights, and yellow lights in the acquired training image set is adjusted. Optionally, a number of traffic lights of different colors in the predetermined proportion is the same or a difference in the number is less than an allowable threshold.

The colors of the traffic light include red, yellow, and green.

Because the probability of the yellow light is actually far lower than that of the red light and the green light, the proportion of the yellow light is far less than that of the red light and the green light in the acquired training images. In the embodiments, in order to improve the accuracy of the classification network, proportions of red, yellow and green may be selected to be predetermined to be the same (for example, red:yellow:green is 1:1:1), or a difference in numbers of red, yellow and green is controlled to be less than the allowable threshold, so that the proportion of the three colors is close to 1:1:1. A new training image set can be formed by extracting training images with the traffic light as the corresponding color from the training image set, or yellow light images in the training image set are repeatedly called, so that the number of the yellow lights images and the number of the red light images and the green light images meet the predetermined proportion. The classification network is trained by the adjusted new training image set, so that the defect that the number of the yellow light images is far less than that of the red light images and the green light images is overcome, and the identification accuracy of the classification network on the yellow light is improved.

Optionally, before the adjusting parameters in the R-FCN and in the multi-task identification network based on the training image set, the method may further include:

initializing at least some of parameters in the multi-task identification network based on parameters of the trained classification network.

Optionally, some or all of the parameters in the multi-task identification network may be initialized based on parameters of the trained classification network, for example, the feature extraction branch and the classification branch in the multi-task identification network are initialized by using the parameters of the trained classification network, where the parameters may include, for example, the size of a convolution kernel, the weight of a convolution connection, etc.

After the classification network for improving the identification accuracy of the yellow light is obtained, an initial training image set is used for training the R-FCN and the multi-task identification network. Before training, some of the parameters in the detection network are initialized with the parameters in the trained classification network, and at this moment, the obtained feature extraction branch and classification branch have a good effect on the color classification of the traffic lights, and the classification accuracy of the yellow light is improved.

In the present disclosure, the traffic light detection method may be applied to the fields of intelligent driving, high-precision maps and the like.

The vehicle-mounted video may be used as an input to output the position and the state of the traffic light, so as to facilitate safe driving of the vehicle.

The method may also be used for establishing a high-precision map and detecting the position of the traffic light in the high-precision map.

In one or more optional embodiments, the method further includes:

determining a state of the traffic light based on the at least two attributes of the traffic light in the image; and

performing intelligent driving control on the vehicle according to the state of the traffic light.

In the embodiments, the at least two attributes of the traffic light are automatically identified, the state of the traffic light in the video stream is obtained, and there is no need for a driver to be distracted and observe the traffic light while driving, so that the driving safety of the vehicle is improved, and the traffic risk caused by human errors is reduced.

Optionally, intelligent driving control includes: sending prompt information or warning information, and/or controlling a driving state of the vehicle according to the state of the traffic light.

Identification of at least two attributes of the traffic light may provide a basis for intelligent driving. Intelligent driving includes automatic driving and auxiliary driving. Under the condition of automatic driving, the driving state of the vehicle (for example, stopping, deceleration, or turning) is controlled according to the state of the traffic light, and prompt information or alarm information may also be sent to inform the driver of the state of the current traffic light. However, under the condition of auxiliary driving, only prompt information or alarm information is sent, the permission of controlling the vehicle still belongs to the driver, and the driver accordingly controls the vehicle according to the prompt information or the alarm information.

Optionally, the method further includes: storing the attributes and state of the traffic light as well as the image corresponding to the traffic light.

In the embodiments, by storing the attributes and state of the traffic light as well as the image corresponding to the traffic light, more information (attributes, states and corresponding images) of the traffic light is obtained, so as to provide more operation bases for intelligent driving. A high-precision map may be established according to the time and the position corresponding to the stored traffic light, and the position of the traffic light in the high-precision map is determined based on the image corresponding to the stored traffic light.

Optionally, the state of the traffic light includes, but is not limited to, a passing-permitted state, a passing-forbidden state, or a waiting state.

The determining a state of the traffic light based on the at least two attributes of the traffic light in the image includes at least one of:

in response to the color of the traffic light being green and/or the shape being a first predetermined shape, determining that the state of the traffic light is a passing-permitted state;

in response to the color of the traffic light being red and/or the shape being a second predetermined shape, determining that the state of the traffic light is a passing-forbidden state; or

in response to the color of the traffic light being yellow and/or the shape being a third predetermined shape, determining that the state of the traffic light is a waiting state.

In view of the existing traffic laws and regulations, the traffic light colors include red, green, and yellow. Different colors correspond to different passing states, red represents prohibition of passing of vehicles and/or pedestrians, green represents that vehicles and/or pedestrians are permitted to pass, and yellow represents that vehicles and/or pedestrians need to stop and wait. Moreover, the shapes of the traffic light may also be included to assist the colors, for example, a plus sign shape (an optional first predetermined shape) represents passing permitted, an X shape (an optional second predetermined shape) represents passing forbidden, and a minus sign shape (an optional third predetermined shape) represents a waiting state. Different coping strategies are provided for states of different traffic lights, automatic and semi-automatic intelligent driving is realized, and the driving safety is improved.

Optionally, the performing intelligent driving control on the vehicle according to the state of the traffic light includes:

in response to the state of the traffic light being a passing-permitted state, controlling the vehicle to execute one or more of operations of starting, keeping the driving state, deceleration, turning, turning on a turn light, turning on a brake light, and other operations required during vehicle passing; and

in response to the state of the traffic light being a passing-forbidden state or a waiting state, controlling the vehicle to execute one or more of operations of stopping, deceleration, and turning on a brake light, and other operations required during the passing-forbidden state or the waiting state of the vehicle.

For example, when the color of the traffic light is green and the shape is an arrow pointing to the left, the automatic turning (a left turn) and/or automatic turn-on of a turn light (a left turn light) of the vehicle may be controlled; and when the color of the traffic light is green and the shape is an arrow pointing forward, the vehicle may be controlled to pass through the intersection with deceleration. Of course, specific control about that how the vehicle travels is based on a comprehensive result of a set destination of the current vehicle and the state of the current traffic light. By automatically controlling the vehicle to execute the operation corresponding to the state of the traffic light, the intelligent driving with higher safety may be realized, the safety of driving is improved, and potential safety hazards caused by manual operation errors are reduced.

A person of ordinary skill in the art may understand that: all or some steps of implementing the forgoing embodiments of the method may be achieved by a program by instructing related hardware; the foregoing program may be stored in a computer-readable storage medium; when the program is executed, steps including the foregoing embodiments of the method are performed; moreover, the foregoing storage medium includes various media capable of storing program codes such as an ROM, an RAM, a magnetic disk, or an optical disk.

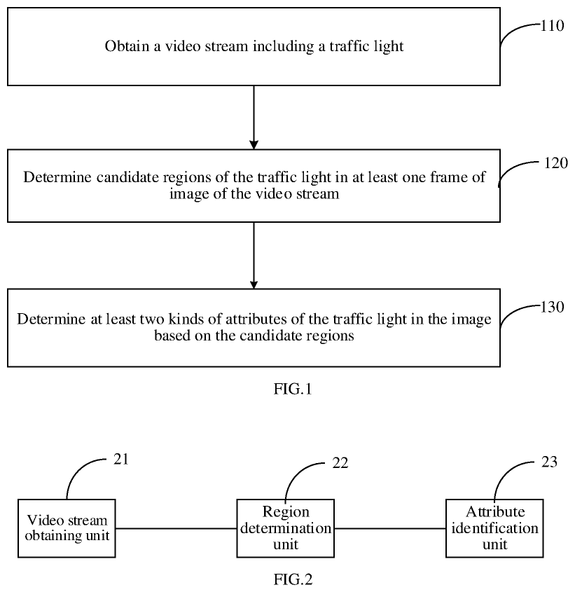

FIG. 2 is a structural schematic diagram of one embodiment of a traffic light detection apparatus of the present disclosure. The traffic light detection apparatus of the embodiment may be used for implementing the embodiments of the traffic light detection method of the present disclosure. As shown in FIG. 2, the apparatus of the embodiment includes:

a video stream obtaining unit 21, configured to obtain a video stream including a traffic light.

Optionally, identification of a traffic light is generally performed based on a vehicle-mounted video recorded in the traveling process of a vehicle. The vehicle-mounted video is parsed to obtain a video stream including at least one frame of image. For example, a video of a forward or surrounding environment of the vehicle can be photographed through a camera apparatus mounted on the vehicle, and if a traffic light exists in the forward or surrounding environment of the vehicle, the traffic light may be photographed by the camera apparatus, and the photographed video stream is a video stream including the traffic light. For the image in the video stream, each frame of image includes the traffic light, or at least one frame of image includes the traffic light.

A region determination unit 22 is configured to determine candidate regions of the traffic light in at least one frame of image of the video stream;

Optionally, candidate regions are determined from an image of the video stream including the traffic light, and the candidate regions refer to regions which may include the traffic light in the image.

Detection of the region of the traffic light may be performed based on a neural network or other types of detection models. In one or more optional embodiments, candidate regions of the traffic light in at least one frame of image of the video stream are determined by using the R-FCN. The signal image is detected through the R-FCN, and candidate regions which may include the traffic light are obtained. The R-FCN can be regarded as an improved version of a Faster RCNN, and the detection speed thereof is faster than the Faster RCNN.

an attribute identification unit 23 is configured to determine at least two attributes of the traffic light in the image based on the candidate regions.

The attributes of the traffic light are used for describing the traffic light, and may be defined according to actual needs, for example, being capable of including a position region attribute for describing an absolute position or relative position of the traffic light, an attribute for describing colors (such as red, green, and yellow) of the traffic light, an attribute for describing shapes (such as circle, linear arrow, and fold line arrow) of the traffic light, and other attributes for describing other aspects of the traffic light.

Based on the traffic light detection apparatus provided according to the embodiments of the present disclosure, by obtaining the at least two attributes of the traffic light, identification of multiple information of the traffic light is realized, thereby reducing the identification time and improving the identification accuracy of the traffic light.

Optionally, the at least two attributes of the traffic light include any two or more of: a position region, colors, and a shape.

Determination of the at least two attributes of the traffic light may be performed based on a neural network or other types of identification models. In one or more optional embodiments, an attribute identification unit 23 is configured to determine, by using a multi-task identification network, at least two attributes of the traffic light in the image based on the candidate regions.

In the embodiments, at least two attributes of the traffic light are identified through a network, and compared with the condition that at least two attributes are identified based on at least two networks respectively, the size of the network is reduced, and the attribute identification efficiency of the traffic light is improved.

Optionally, the multi-task identification network includes a feature extraction branch and at least two task branches respectively connected to the feature extraction branch, and different task branches are configured to determine different kinds of attributes of the traffic light.

The attribute identification unit 23 includes:

a feature extraction module, configured to perform feature extraction on the candidate regions based on the feature extraction branch to obtain candidate features; and

a branch attribute module, configured to process the candidate features respectively based on the at least two task branches to obtain at least two attributes of the traffic light in the image.

Optionally, the at least two task branches include, but are not limited to, a detection branch, an identification branch, and a classification branch.

The branch attribute module is configured to: perform position detection on the candidate features through the detection branch to determine the position region of the traffic light; perform color classification on the candidate features through the classification branch to determine a color of the position region at which the traffic light is located, and to determine a color of the traffic light; and perform shape identification on the candidate features through the identification branch to determine a shape of the position region at which the traffic light is located, and to determine the shape of the traffic light.

In one or more optional embodiments, the apparatus further includes:

a key point determining unit, configured to perform key point identification on at least one frame of image in the video stream to determine a key point of the traffic light in the image;

a key point tracking unit, configured to track the key point of the traffic light in the video stream to obtain a tracking result; and

a position adjusting unit, configured to adjust the position region of the traffic light based on the tracking result.

There may be little difference between consecutive frames of the video stream. If the position identification of the traffic light is performed only based on the candidate regions of the traffic light in each frame of image, the position regions in the consecutive frames may be identified to be the same position regions, and therefore the identified position regions are not accurate. In the embodiments, by performing key point identification on the image, the position region of the traffic light in the image is determined based on the key point, and the position of the traffic light obtained by the multi-task identification network is adjusted based on the position region of the key point, thereby improving the accuracy of position region identification.

Key point identification and/or tracking may be realized based on any one of the technologies that can achieve key point identification and/or tracking in the prior art. Optionally, the key point of the traffic light in the video stream may be tracked by a static key point tracking technology, so as to obtain a region where the key point of the traffic light may be located in the video stream.

Optionally, the key point tracking unit is configured to: be based on a distance between the key points of the traffic light in two consecutive frames of images; and track the key point of the traffic light in the video stream based on the distance between the key points of the traffic light.

In the embodiments, the two consecutive frames may be two acquisition frames with consecutive time sequences in the video stream, or two detection frames with consecutive time sequences in the video stream (because frame-by-frame detection or sampling detection may be performed in the video stream, the meaning of the detection frame and the acquisition frame is not completely the same); the key points of the traffic light of a plurality of consecutive two frames of images in the video stream are correlated, so that the key point of the traffic light may be tracked in the video stream, and the position region of each frame of image in the video stream may be adjusted based on the tracking result. Optionally, the key point of the traffic light in the video stream may be tracked based on Hamming distance, Euclidean distance, Joint Bayesian distance, or cosine distance between the key points of the traffic light. The embodiments do not limit what distance between the key points of the traffic light is based.

Optionally, the key point tracking unit is configured to, when tracking the key point of the traffic light in the video stream based on the distance between the key points of the traffic light, determine the position region of the key point of a same traffic light in the two consecutive frames of images based on the distance between the key points of the traffic light; and track the key point of the traffic light in the video stream according to the position region of the key point of the same traffic light in the two consecutive frames of images.

In one or more optional embodiments, the position adjusting unit is configured to: compare whether the position region in the tracking result overlaps the position region of the traffic light to obtain a comparison result; and adjust the position region of the traffic light based on the comparison result.

The position region of the traffic light is adjusted based on the tracking result, so that the position region of the traffic light is more stable, and is more suitable for being applied to video scenes.

In the embodiments, the position region corresponding to the key point of the traffic light in at least one frame of image in the video stream may be determined based on the tracking result, and when the ratio of the overlapping part between the position region in the tracking result and the position region of the traffic light in the position region of the traffic light exceeds a set ratio, it can be determined that the position region in the tracking result overlaps the position region of the traffic light, and otherwise, the position region in the tracking result does not overlap the position region of the traffic light.

Optionally, the position adjusting unit is configured to, when adjusting the position region of the traffic light based on the comparison result, replace the position region of the traffic light with the position region corresponding to the key point of the traffic light in response to the position region corresponding to the key point of the traffic light not overlapping the position region of the traffic light.

In one or more optional embodiments, the apparatus may further include:

a pre-training unit, configured to train the R-FCN based on an acquired training image set, the training image set including a plurality of training images with annotation attributes;

and

a training unit, configured to adjust parameters in the R-FCN and in the multi-task identification network based on the training image set.

In a real scene, the yellow light in the traffic light is only a transition state between the red light and the green light, and therefore, the duration is shorter than that of the red light and the green light. In the prior art, the detection frame based on the R-FCN only inputs a limited image at a time, and the number of yellow lights in the image is less than that of the red light and the green light, and therefore, the detection network cannot be effectively trained, and the sensitivity of the model to the yellow light cannot be improved. Therefore, in the present disclosure, the position, the color, and/or the shape of the traffic light may be identified simultaneously by training the R-FCN and the multi-task identification network.

In order to improve the sensitivity of the detection network to the yellow light, optionally, further included between the pre-training unit and the training unit is:

a classification training unit, configured to obtain, based on the training image set, a new training image set with a color proportion of the traffic light conforming to a predetermined proportion; and train a classification network based on the new training image set, the classification network being configured to classify training images based on the color of the traffic light.

Optionally, a number of traffic lights of different colors in the predetermined proportion is the same or a difference in the number is less than an allowable threshold.

The colors of the traffic light include red, yellow, and green.

Because the probability of the yellow light is actually far lower than that of the red light and the green light, the proportion of the yellow light is far less than that of the red light and the green light in the acquired training images. In the embodiments, in order to improve the accuracy of the classification network, proportions of red, yellow and green may be selected to be predetermined to be the same (for example, red:yellow:green is 1:1:1), or a difference in numbers of red, yellow and green is controlled to be less than the allowable threshold, so that the proportion of the three colors is close to 1:1:1. A new training image set can be formed by extracting training images with the traffic light as the corresponding color from the training image set, or yellow light images in the training image set are repeatedly called, so that the number of the yellow lights images and the number of the red light images and the green light images meet the predetermined proportion. The classification network is trained by the adjusted new training image set, so that the defect that the number of the yellow light images is far less than that of the red light images and the green light images is overcome, and the identification accuracy of the classification network on the yellow light is improved.

Optionally, after the classification training unit, the apparatus may further include:

an initialization unit, configured to initialize at least some of parameters in the multi-task identification network based on parameters of the trained classification network.

In one or more optional embodiments, the apparatus in the embodiments may further include:

a state determination unit, configured to determine a state of the traffic light based on the at least two attributes of the traffic light in the image; and

an intelligent control unit, configured to perform intelligent driving control on the vehicle according to the state of the traffic light.

In the embodiments, the at least two attributes of the traffic light are automatically identified, the state of the traffic light in the video stream is obtained, and there is no need for a driver to be distracted and observe the traffic light while driving, so that the driving safety of the vehicle is improved, and the traffic risk caused by human errors is reduced.

Optionally, intelligent driving control includes: sending prompt information or warning information, and/or controlling a driving state of the vehicle according to the state of the traffic light.

Optionally, the apparatus further includes:

a storage unit, configured to store the attributes and state of the traffic light as well as the image corresponding to the traffic light.

Optionally, the state of the traffic light includes, but is not limited to, a passing-permitted state, a passing-forbidden state, or a waiting state.

a state determination unit is configured to, in response to the color of the traffic light being green and/or the shape being a first predetermined shape, determine that the state of the traffic light as the passing-permitted state;

in response to the color of the traffic light being red and/or the shape being a second predetermined shape, determine that the state of the traffic light is a passing-forbidden state;

and

in response to the color of the traffic light being yellow and/or the shape being a third predetermined shape, determine that the state of the traffic light is a waiting state.

Optionally, the intelligent control unit is configured to, in response to the state of the traffic light being a passing-permitted state, control the vehicle to execute one or more operations of starting, keeping the driving state, deceleration, turning, turning on a turn light, and turning on a brake light; and

in response to the state of the traffic light being a passing-forbidden state or a waiting state, control the vehicle to execute one or more operations of stopping, deceleration, and turning on a brake light.

For the working process and the setting mode of any embodiment of the traffic light detection apparatus provided by the embodiments of the present disclosure, reference may be made to the specific descriptions of the corresponding method embodiment of the present disclosure, and details are not described herein again due to space limitation.

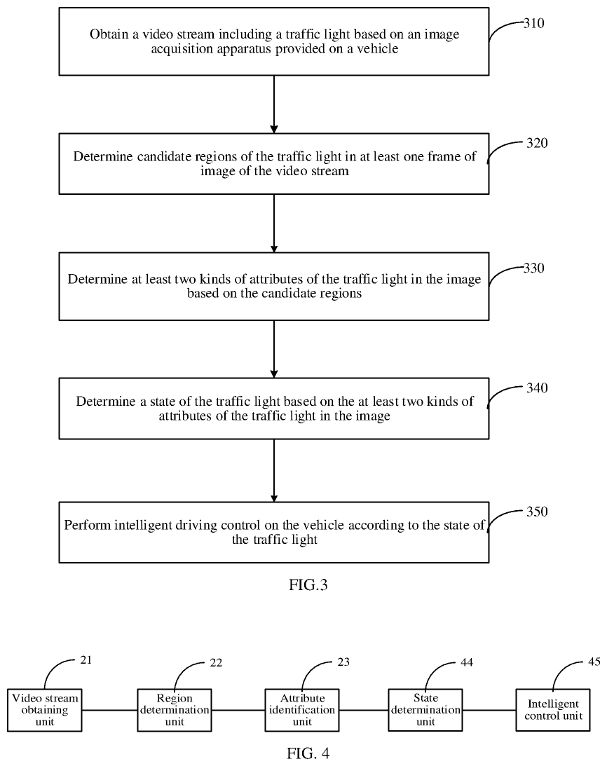

FIG. 3 is a flow chart of one embodiment of an intelligent driving method of the present disclosure. As shown in FIG. 3, the method in the present embodiment includes the following steps.

At step 310, a video stream including a traffic light is obtained based on an image acquisition apparatus provided on a vehicle.

Optionally, identification of a traffic light is performed based on a vehicle-mounted video recorded in the traveling process of a vehicle. The vehicle-mounted video is parsed to obtain a video stream including at least one frame of image. For example, a video of a forward or surrounding environment of the vehicle can be photographed through a camera apparatus mounted on the vehicle, and if a traffic light exists in the forward or surrounding environment of the vehicle, the traffic light may be photographed by the camera apparatus, and the photographed video stream is a video stream including the traffic light. For the image in the video stream, each frame of image includes the traffic light, or at least one frame of image includes the traffic light.

In one optional example, step 310 may be performed by a processor by invoking a corresponding instruction stored in a memory, or may be performed by a video stream obtaining module 21 run by the processor.

At step 320, candidate regions of the traffic light in at least one frame of image of the video stream are determined.

In one optional example, step 320 may be performed by a processor by invoking a corresponding instruction stored in a memory, and may also be performed by a region determination unit 22 run by the processor.

At step 330, at least two attributes of the traffic light in the image are determined based on the candidate regions.

The attributes of the traffic light are used for describing the traffic light, and may be defined according to actual needs, for example, being capable of including a position region attribute for describing an absolute position or relative position of the traffic light, an attribute for describing colors (such as red, green, and yellow) of the traffic light, an attribute for describing shapes (such as circle, linear arrow, and fold line arrow) of the traffic light, and other attributes for describing other aspects of the traffic light.

Optionally, the at least two attributes of the traffic light include any two or more of: a position region, colors, and a shape.

Optionally, the colors of the traffic light include red, yellow and green, and the shape thereof includes an arrow shape, a circle or other shapes. For the traffic lights in different shapes, if only the position of the traffic light is recognized, the signal cannot be identified accurately. Therefore, the embodiments are based on identification of at least two of the position region, the colors, and the shape, for example, when the position region and the color of the traffic light are determined, the position of the current traffic light in the image (corresponding to which direction of the vehicle) may be determined, a display state (red, green, or yellow correspond to different states respectively) of the traffic light may be determined through the color, and auxiliary driving or automatic driving may be realized by identifying different states of the traffic light; when the position region and the shape of the traffic light are determined, the position of the current traffic light in the image (corresponding to which direction of the vehicle) may be determined, and the display state (for example, arrows towards different directions represent human body graphs in different states or different shapes represent different states) of the traffic light may be determined through the shape; when the color and the shape of the traffic light are determined, the state of the current traffic light may be determined based on a combination of the color and the shape (for example, the green arrow pointing to the left represents a left turn, and the red arrow pointing to the front represents passing forbidden ahead); and when the position region, the color, and the shape of the traffic light are determined, on the basis that the position of the traffic light in the image is obtained, the state of the current traffic light may be determined based on the combination of the color and the shape.

In one optional example, step 330 may be performed by a processor by invoking a corresponding instruction stored in a memory, or may be performed by an attribute identification unit 23 run by the processor.

At step 340, a state of the traffic light is determined based on the at least two attributes of the traffic light in the image.

The existing image processing method may only be used for processing one task (e.g., one of position identification or color classification). However, the traffic light includes information such as position region, colors, and a shape, and when a state of the traffic light needs to be determined, the position region of the traffic light needs to be determined and the color or shape thereof also needs to be determined. Therefore, if the conventional image processing method is applied, at least two neural networks are required to process a video stream, and the processing results also need to be combined, so that the state of the current traffic light may be determined. In the embodiments, at least two attributes of the traffic light are obtained at the same time, the state of the traffic light is determined based on the at least two attributes, and therefore, the state of the traffic light may be rapidly and accurately identified.

In one optional example, step 340 may be performed by a processor by invoking a corresponding instruction stored in a memory, and may also be performed by a state determination unit 44 run by the processor.

At step 350, intelligent driving control is performed on the vehicle according to the state of the traffic light.

In one optional example, step 350 may be performed by a processor by invoking a corresponding instruction stored in a memory, and may also be performed by an intelligent control unit 45 run by the processor.

In the embodiments, a video stream may be obtained in real time through an image acquisition device on a vehicle, and attributes of a traffic light may be identified in real time so as to determine the state of the traffic light. Intelligent driving is realized based on the state of the traffic light. There is no need for a driver to be distracted and observe the traffic light while driving, which reduces the hidden danger of traffic safety. To a certain extent, the traffic risk caused by human errors is reduced. The intelligent driving may include auxiliary driving and automatic driving, in general, auxiliary driving utilizes the traffic light for early warning prompt, and automatic driving utilizes the traffic light for driving control.

Optionally, intelligent driving control includes: sending prompt information or warning information, and/or controlling a driving state of the vehicle according to the state of the traffic light.

Identification of at least two attributes of the traffic light may provide a basis for intelligent driving. Intelligent driving includes automatic driving and auxiliary driving. Under the condition of automatic driving, the driving state of the vehicle (for example, stopping, deceleration, or turning) is controlled according to the state of the traffic light, and prompt information or alarm information may also be sent to inform the driver of the state of the current traffic light. However, under the condition of auxiliary driving, only prompt information or alarm information is sent, the permission of controlling the vehicle still belongs to the driver, and the driver accordingly controls the vehicle according to the prompt information or the alarm information.

Optionally, the intelligent driving method provided according to the embodiments of the present application further includes:

storing the attributes and state of the traffic light as well as the image corresponding to the traffic light.

In the embodiments, by storing the attributes and the state of the traffic light as well as the image corresponding to the traffic light, more information (attributes, states and corresponding images) of the traffic light is obtained, so as to provide more operation bases for intelligent driving. A high-precision map may be established according to the time and the position corresponding to the stored traffic light, and the position of the traffic light in the high-precision map is determined based on the image corresponding to the stored traffic light.

Optionally, the state of the traffic light includes, but is not limited to, a passing-permitted state, a passing-forbidden state, and a waiting state.

Step 340 may include:

in response to the color of the traffic light being green and/or the shape being a first predetermined shape, determining that the state of the traffic light is a passing-permitted state;

in response to the color of the traffic light being red and/or the shape being a second predetermined shape, determining that the state of the traffic light is a passing-forbidden state;

and

in response to the color of the traffic light being yellow and/or the shape being a third predetermined shape, determining that the state of the traffic light is a waiting state.

In view of the existing traffic laws and regulations, the colors of the traffic light include red, green, and yellow. Different colors correspond to different passing states, red represents prohibition of passing of vehicles and/or pedestrians, green represents that vehicles and/or pedestrians are permitted to pass, and yellow represents that vehicles and/or pedestrians need to stop and wait. Moreover, the shapes of the traffic light may also be included to assist the colors, for example, a plus sign shape (an optional first predetermined shape) represents passing permitted, an X shape (an optional second predetermined shape) represents passing forbidden, and a minus sign shape (an optional third predetermined shape) represents a waiting state. Different coping strategies are provided for states of different traffic lights, automatic and semi-automatic intelligent driving is realized, and the driving safety is improved.

Optionally, step 350 may include:

in response to the state of the traffic light being a passing-permitted state, controlling the vehicle to execute one or more of operations of starting, keeping the driving state, deceleration, turning, turning on a turn light, turning on a brake light, and other operations required during vehicle passing; and

in response to the state of the traffic light being a passing-forbidden state or a waiting state, controlling the vehicle to execute one or more of operations of stopping, deceleration, and turning on a brake light, and other operations required during the passing-forbidden state or the waiting state of the vehicle.

For example, when the color of the traffic light is green and the shape is an arrow pointing to the left, the automatic turning (a left turn) and/or automatic turn-on of a turn light (a left turn light) of the vehicle may be controlled; and when the color of the traffic light is green and the shape is an arrow pointing forward, the vehicle may be controlled to pass through the intersection with deceleration. Of course, specific control about that how the vehicle travels is based on a comprehensive result of a set destination of the current vehicle and the state of the current traffic light. By automatically controlling the vehicle to execute the operation corresponding to the state of the traffic light, the intelligent driving with higher safety may be realized, and potential safety hazards caused by manual operation errors are reduced.

A person of ordinary skill in the art may understand that: all or some steps of implementing the forgoing embodiments of the method may be achieved by a program by instructing related hardware; the foregoing program may be stored in a computer-readable storage medium; when the program is executed, steps including the foregoing embodiments of the method are performed; moreover, the foregoing storage medium includes various media capable of storing program codes such as an ROM, an RAM, a magnetic disk, or an optical disk.

FIG. 4 is a schematic structural diagram of one embodiment of an intelligent driving apparatus according to the present disclosure. The intelligent driving apparatus in the embodiment may be used for implementing the embodiments of the intelligent driving method of the present disclosure. As shown in FIG. 4, the apparatus in the embodiment includes:

a video stream obtaining unit 21, configured to obtain a video stream including a traffic light based on an image acquisition apparatus provided on a vehicle.

Optionally, identification of a traffic light is performed based on a vehicle-mounted video recorded in the traveling process of a vehicle. The vehicle-mounted video is parsed to obtain a video stream including at least one frame of image. For example, a video of a forward or surrounding environment of the vehicle can be photographed through a camera apparatus mounted on the vehicle, and if a traffic light exists in the forward or surrounding environment of the vehicle, the traffic light may be photographed by the camera apparatus, and the photographed video stream is a video stream including the traffic light. For the image in the video stream, each frame of image includes the traffic light, or at least one frame of image includes the traffic light.

A region determination unit 22 is configured to determine candidate regions of the traffic light in at least one frame of image of the video stream.

An attribute identification unit 23 is configured to determine at least two attributes of the traffic light in the image based on the candidate regions.

The attributes of the traffic light are used for describing the traffic light, and may be defined according to actual needs, for example, being capable of including a position region attribute for describing an absolute position or relative position of the traffic light, an attribute for describing colors (such as red, green, and yellow) of the traffic light, an attribute for describing shapes (such as circle, linear arrow, and fold line arrow) of the traffic light, and other attributes for describing other aspects of the traffic light.

A state determination unit 44 is configured to determine a state of the traffic light based on the at least two attributes of the traffic light in the image.

The existing image processing method may only be used for processing one task (e.g., one of position identification or color classification). However, the traffic light includes information such as position region, colors, and a shape, and when a state of the traffic light needs to be determined, the position region of the traffic light needs to be determined and the color or shape thereof also needs to be determined. Therefore, if the conventional image processing method is applied, at least two neural networks are required to process a video stream, and the processing results also need to be combined, so that the state of the current traffic light may be determined. In the embodiments, at least two attributes of the traffic light are obtained at the same time, the state of the traffic light is determined based on the at least two attributes, and therefore, the state of the traffic light may be rapidly and accurately identified.

An intelligent control unit 45 is configured to perform intelligent driving control on the vehicle according to the state of the traffic light.

In the embodiments, a video stream may be obtained in real time through an image acquisition device on a vehicle, and attributes of a traffic light may be identified in real time so as to determine the state of the traffic light. Intelligent driving is realized based on the state of the traffic light. There is no need for a driver to be distracted and observe the traffic light while driving, which reduces the hidden danger of traffic safety. To a certain extent, the traffic risk caused by human errors is reduced. The intelligent driving may include auxiliary driving and automatic driving, in general, auxiliary driving utilizes the traffic light for early warning prompt, and automatic driving utilizes the traffic light for driving control.

Optionally, intelligent driving control includes: sending prompt information or warning information, and/or controlling a driving state of the vehicle according to the state of the traffic light.

Optionally, the apparatus further includes:

a storage unit, configured to store the attributes and state of the traffic light as well as the image corresponding to the traffic light.

Optionally, the at least two attributes of the traffic light include any two or more of: a position region, colors, and a shape.

Optionally, the state of the traffic light includes, but is not limited to, a passing-permitted state, a passing-forbidden state, and a waiting state.

A state determination unit 44 is configured to, in response to the color of the traffic light being green and/or the shape being a first predetermined shape, determine that the state of the traffic light is a passing-permitted state;

in response to the color of the traffic light being red and/or the shape being a second predetermined shape, determine that the state of the traffic light is a passing-forbidden state;

and

in response to the color of the traffic light being yellow and/or the shape being a third predetermined shape, determine that the state of the traffic light is a waiting state.

Optionally, the intelligent control unit 45 is configured to, in response to the state of the traffic light being a passing-permitted state, control the vehicle to execute one or more operations of starting, keeping the driving state, deceleration, turning, turning on a turn light, and turning on a brake light; and

in response to the state of the traffic light being a passing-forbidden state or a waiting state, control the vehicle to execute one or more operations of stopping, deceleration, and turning on a brake light.

For the working process and the setting mode of any embodiment of the intelligent driving apparatus provided by the embodiments of the present disclosure, reference may be made to the specific descriptions of the corresponding method embodiment of the present disclosure, and details are not described herein again due to space limitation.

A vehicle provided according to another aspect of the embodiments of the present disclosure includes the traffic light detection apparatus according to any one of the foregoing embodiments or the intelligent driving apparatus according to any one of the foregoing embodiments.

An electronic device provided according to another aspect of the embodiments of the present disclosure includes a processor, where the processor includes the traffic light detection apparatus according to any one of the foregoing embodiments or the intelligent driving apparatus according to any one of the foregoing embodiments.

An electronic device provided according to yet another aspect of the embodiments of the present disclosure includes: a memory, configured to store executable instructions;

and a processor, configured to communicate with the memory to execute the executable instructions so as to complete operations of the traffic light detection method according to any one of the foregoing embodiments or operations of the intelligent driving method according to any one of the foregoing embodiments.

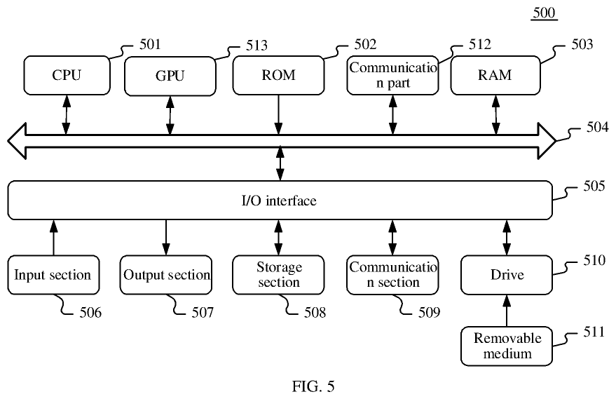

The embodiments of the present disclosure further provide an electronic device which, for example, is a mobile terminal, a Personal Computer (PC), a tablet computer, a server, and the like. Referring to FIG. 5 below, a schematic structural diagram of an electronic device 500, which is a terminal device or a server, suitable for implementing the embodiments of the present disclosure is shown. As shown in FIG. 5, the electronic device 500 includes one or more processors, a communication part, or the like. The one or more processors are, for example, one or more Central Processing Units (CPUs) 501 and/or one or more Graphic Processing Units (GPUs) 513, and may execute appropriate actions and processing according to executable instructions stored in a Read-Only Memory (ROM) 502 or executable instructions loaded from a storage section 508 to a Random Access Memory (RAM) 503. The communication part 512 may include, but is not limited to, a network card. The network card may include, but is not limited to, an Infiniband (IB) network card.

The processor may communicate with the ROM 502 and/or the RAM 503 to execute executable instructions, is connected to the communication part 512 by means of a bus 504, and communicates with other target devices by means of the communication part 512, so as to complete corresponding operations of any of the methods provided by the embodiments of the present disclosure, for example, obtaining a video stream including a traffic light; determining candidate regions of the traffic light in at least one frame of image of the video stream; and determining at least two attributes of the traffic light in the image based on the candidate regions.

In addition, the RAM 503 further stores various programs and data required for operations of the apparatus. The CPU 501, the ROM 502, and the RAM 503 are connected to each other via the bus 504. In the presence of the RAM 503, the ROM 502 is an optional module. The RAM 503 stores executable instructions, or writes the executable instructions into the ROM 502 during running, where the executable instructions cause the CPU 501 to execute corresponding operations of the foregoing communication method. An input/output (I/O) interface 505 is also connected to the bus 504. The communication part 512 may be integrated, or may be configured to have a plurality of sub-modules (for example, a plurality of IB network cards) connected to the bus.

The following components are connected to the I/O interface 505: an input section 506 including a keyboard, a mouse, or the like; an output section 507 including a Cathode-Ray Tube (CRT), a Liquid Crystal Display (LCD), a speaker, or the like; the storage section 508 including a hard disk, or the like; and a communication section 509 of a network interface card including an LAN card, a modem, or the like. The communication section 509 performs communication processing via a network such as the Internet. A drive 510 is also connected to the I/O interface 505 according to requirements. A removable medium 511 such as a magnetic disk, an optical disk, a magneto-optical disk, a semiconductor memory or the like is mounted on the drive 510 according to requirements, so that a computer program read from the removable medium is installed on the storage section 508 according to requirements.

It should be noted that the architecture illustrated in FIG. 5 is merely an optional implementation mode. During specific practice, the number and types of the components in FIG. 5 are selected, decreased, increased, or replaced according to actual requirements. Different functional components are separated or integrated or the like. For example, the GPU 513 and the CPU 501 are separated, or the GPU 513 is integrated on the CPU 501, and the communication part 512 are separated from or integrated on the CPU 501 or the GPU 513 or the like. These alternative implementations all fall within the scope of protection of the present disclosure.

Particularly, a process described above with reference to a flowchart according to the embodiments of the present disclosure may be implemented as a computer software program. For example, the embodiments of the present disclosure include a computer program product, which includes a computer program tangibly contained on a machine-readable medium. The computer program includes a program code configured to execute the method shown in the flowchart. The program code may include corresponding instructions for correspondingly executing the method steps method provided by the embodiments of the present disclosure, for example, obtaining a video stream including a traffic light; determining candidate regions of the traffic light in at least one frame of image of the video stream; and determining at least two attributes of the traffic light in the image based on the candidate regions. In such embodiment, the computer program is downloaded and installed from the network through the communication section 509, and/or is installed from the removable medium 511. The computer program, when being executed by the CPU 501, executes operations of the foregoing functions defined in the methods of the present disclosure.

A computer readable storage medium provided according to still another aspect of the embodiments of the present disclosure is configured to store computer readable instructions, where when the instructions are executed, operations of the traffic light detection method according to any one of the foregoing embodiments or operations of the intelligent driving method according to any one of the foregoing embodiments are executed.

A computer program product provided according to yet another aspect of the embodiments of the present disclosure includes a computer readable code, where when the computer readable code runs in a device, a processor in the device executes instructions for implementing the traffic light detection method according to any one of the foregoing embodiments or the intelligent driving method according to any one of the foregoing embodiments.

Various embodiments in this description are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The methods and apparatuses of the present disclosure are implemented in many manners. For example, the methods and apparatuses of the present disclosure may be implemented by using software, hardware, firmware, or any combination of software, hardware, and firmware. Unless otherwise specially stated, the foregoing sequences of steps of the methods are merely for description, and are not intended to limit the steps of the methods of the present disclosure. In addition, in some embodiments, the present disclosure may be implemented as programs recorded in a recording medium. The programs include machine-readable instructions for implementing the methods according to the present disclosure. Therefore, the present disclosure further covers the recording medium storing the programs for performing the methods according to the present disclosure.

The descriptions of the present application are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. A traffic light detection method, comprising:
obtaining a video stream comprising a traffic light;
determining a candidate region of the traffic light in at least one frame of image of the video stream; and
determining at least two attributes of the traffic light in the at least one frame of image based on the candidate region;
wherein the at least two attributes of the traffic light comprise any two or more of: a position region, a color, or a shape.

2. The method according to claim 1, wherein determining the candidate region of the traffic light in at least one frame of image of the video stream comprises:
determining the candidate region of the traffic light in at least one frame of image of the video stream by using a region-based fully convolutional network;
wherein determining at least two attributes of the traffic light in the at least one frame of image based on the candidate region comprises:
determining, by using a multi-task identification network, the at least two attributes of the traffic light in the at least one frame of image based on the candidate region.

3. The method according to claim 2, wherein the multi-task identification network comprises:
a feature extraction branch, and
at least two task branches respectively connected to the feature extraction branch, wherein different task branches are configured to determine different attributes of the traffic light;
determining, by using the multi-task identification network, the at least two attributes of the traffic light in the at least one frame of image based on the candidate region comprises:
performing feature extraction on the candidate region based on the feature extraction branch to obtain a candidate feature; and
processing the candidate feature respectively based on the at least two task branches to obtain the at least two attributes of the traffic light in the at least one frame of image;
wherein the at least two task branches comprise: a detection branch, an identification branch, and a classification branch;
processing the candidate feature respectively based on the at least two task branches to obtain the at least two attributes of the traffic light in the at least one frame of image comprises:
performing position detection on the candidate feature through the detection branch to determine the position region of the traffic light;
performing color classification on the candidate feature through the classification branch to determine a color of the position region at which the traffic light is located, and to determine a color of the traffic light; and
performing shape identification on the candidate feature through the identification branch to determine a shape of the position region at which the traffic light is located, and to determine the shape of the traffic light.

4. The method according to claim 1, the method further comprises: before determining the candidate region of the traffic light in the at least one frame of image of the video stream,
performing key point identification on the at least one frame of image in the video stream to determine a key point of the traffic light in each of the at least one frame of image;
tracking the key points of the traffic light in the video stream to obtain a tracking result; and
adjusting the position region of the traffic light based on the tracking result.

5. The method according to claim 4, wherein tracking the key points of the traffic light in the video stream comprises:
determining a distance between key points of the traffic light in two consecutive frames of images; and
tracking the key points of the traffic light in the video stream based on the distance between the key points of the traffic light.

6. The method according to claim 5, wherein tracking the key points of the traffic light in the video stream based on the distance between the key points of the traffic light comprises:
determining position regions of the key points of the traffic light in the two consecutive frames of images based on the distance between the key points of the traffic light; and
tracking the key points of the traffic light in the video stream according to the position regions of the key points of the traffic light in the two consecutive frames of images.

7. The method according to claim 4, wherein adjusting the position region of the traffic light based on the tracking result comprises:
comparing whether the tracking result overlaps the position region of the traffic light to obtain a comparison result; and
adjusting the position region of the traffic light based on the comparison result.

8. The method according to claim 7, wherein adjusting the position region of the traffic light based on the comparison result comprises:
in response to a position region corresponding to the key point of the traffic light not overlapping the position region of the traffic light, replacing the position region of the traffic light with the position region corresponding to the key point of the traffic light.

9. The method according to claim 2, wherein the method further comprises: before determining the candidate region of the traffic light in the at least one frame of image of the video stream,
training the region-based fully convolutional network based on an acquired training image set, the training image set comprising a plurality of training images with annotation attributes; and
adjusting parameters in the region-based fully convolutional network and in the multi-task identification network based on the training image set.

10. The method according to claim 9, wherein the method further comprises: before the adjusting parameters in the region-based fully convolutional network and in the multi-task identification network based on the training image set,
obtaining, based on the training image set, a new training image set with a traffic light color proportion conforming to a predetermined proportion; and
training a classification network based on the new training image set, the classification network being configured to classify training images based on traffic light colors;
wherein a number of traffic lights with different colors in the predetermined proportion is the same or a difference in the number is less than an allowable threshold; and
the traffic light colors comprise red, yellow, and green.

11. The method according to claim 10, wherein the method further comprises: before adjusting parameters in the region-based fully convolutional network and in the multi-task identification network based on the training image set,
initializing at least some of parameters in the multi-task identification network based on parameters of the trained classification network.

12. The method according to claim 1, further comprising:
determining a state of the traffic light based on the at least two attributes of the traffic light in the at least one frame of image; and
performing intelligent driving control on a vehicle according to the state of the traffic light;
wherein the intelligent driving control comprises:
sending prompt information or warning information, and/or
controlling a driving state of the vehicle according to the state of the traffic light.

13. The method according to claim 12, further comprising:
storing the attributes and state of the traffic light as well as the at least one frame of image corresponding to the traffic light.

14. The method according to claim 12, wherein the state of the traffic light comprises:
a passing-permitted state, a passing-forbidden state, or a waiting state;
determining the state of the traffic light based on the at least two attributes of the traffic light in the at least one frame of image comprises at least one of:
in response to a color of the traffic light being green and/or a shape of the traffic light being a first predetermined shape, determining that the state of the traffic light is the passing-permitted state;
in response to the color of the traffic light being red and/or the shape of the traffic light being a second predetermined shape, determining that the state of the traffic light is the passing-forbidden state; or
in response to the color of the traffic light being yellow and/or the shape of the traffic light being a third predetermined shape, determining that the state of the traffic light is the waiting state;
wherein performing intelligent driving control on the vehicle according to the state of the traffic light comprises:
in response to the state of the traffic light being the passing-permitted state, controlling the vehicle to execute one or more operations of starting, keeping the driving state, deceleration, turning, turning on a turn light, or turning on a brake light; and
in response to the state of the traffic light being the passing-forbidden state or the waiting state, controlling the vehicle to execute one or more operations of stopping, deceleration, or turning on a brake light.

15. An intelligent driving method, comprising:
obtaining a video stream comprising a traffic light based on an image acquisition apparatus provided on a vehicle;
determining a candidate region of the traffic light in at least one frame of image of the video stream; and
determining at least two attributes of the traffic light in the at least one frame of image based on the candidate region;
determining a state of the traffic light based on the at least two attributes of the traffic light in the image; and
performing intelligent driving control on the vehicle according to the state of the traffic light;
wherein the at least two attributes of the traffic light comprise any two or more of: a position region, a color, or a shape.

16. The method according to claim 15, wherein the intelligent driving control comprises:
sending prompt information or warning information, and/or
controlling a driving state of the vehicle according to the state of the traffic light;
wherein the method further comprising:
storing the attributes and state of the traffic light as well as the at least one frame of image corresponding to the traffic light.

17. The method according to claim 15, wherein the state of the traffic light comprises: a passing-permitted state, a passing-forbidden state, or a waiting state;
determining the state of the traffic light based on the at least two attributes of the traffic light in the at least one frame of image comprises:
in response to a color of the traffic light being green and/or a shape of the traffic light being a first predetermined shape, determining that the state of the traffic light is the passing-permitted state;
in response to the color of the traffic light being red and/or the shape of the traffic light being a second predetermined shape, determining that the state of the traffic light is the passing-forbidden state; and
in response to the color of the traffic light being yellow and/or the shape of the traffic light being a third predetermined shape, determining that the state of the traffic light is the waiting state;
wherein performing intelligent driving control on the vehicle according to the state of the traffic light comprises:
in response to the state of the traffic light being the passing-permitted state, controlling the vehicle to execute one or more operations of starting, keeping the driving state, deceleration, turning, turning on a turn light, or turning on a brake light; and
in response to the state of the traffic light being the passing-forbidden state or the waiting state, controlling the vehicle to execute one or more operations of stopping, deceleration, or turning on a brake light.

18. An electronic device, comprising: a memory configured to store executable instructions; and
a processor, configured to communicate with the memory to execute the executable instructions so as to perform operations comprising:
obtaining a video stream comprising a traffic light;
determining a candidate region of the traffic light in at least one frame of image of the video stream; and
determining at least two attributes of the traffic light in the at least one frame of image based on the candidate region;
wherein the at least two attributes of the traffic light comprise any two or more of: a position region, a color, or a shape.

19. An electronic device, comprising: a memory configured to store executable instructions; and
a processor, configured to communicate with the memory to execute the executable instructions so as to perform operations of the intelligent driving method according to claim 15.

20. A non-transitory computer readable storage medium for storing computer readable instructions, wherein when the computer readable instructions are executed, operations of the traffic light detection method according to claim 1 are executed.
